(19) United States
(12) Patent Application Publication
(10) Pub. No.: US 2024/0267756 A1
(43) Pub. Date: Aug. 8, 2024

(54) SYSTEM AND METHODS FOR NETWORK CELL MANAGEMENT AND MIMO MODE SELECTION

(71) Applicant: Aira Technologies, Inc., Saratoga, CA (US)

(72) Inventors: Babak Jafarian, Mountain View, CA (US); RaviKiran Gopalan, Saratoga, CA (US); Yihan Jiang, Cupertino, CA (US); Arman Rahimzamani, Saratoga, CA (US); Sanjiv Nanda, San Diego, CA (US); Anand Chandrasekher, Saratoga, CA (US)

(21) Appl. No.: 18/417,648

(22) Filed: Jan. 19, 2024

Related U.S. Application Data
(60) Provisional application No. 63/443,569, filed on Feb. 6, 2023.

(51) Int. Cl. H04W 24/02; H04W 24/08

(52) U.S. Cl. CPC H04W 24/02; H04W 24/08

(57) ABSTRACT

The methods and systems proposed herein use a collection of RAN key performance indicators, initial or current RAN configuration, and, optionally, network-operator provided optimization criteria to update the network's RAN configuration according to an output determined by the predictive network cell management system.

### CROSS REFERENCE TO RELATED APPLICATIONS

The present application claims priority to U.S. Provisional Patent Application No. 63/443,569, filed Feb. 6, 2023, entitled “SYSTEM AND METHODS FOR NETWORK CELL MANAGEMENT AND MIMO MODE SELECTION,” the disclosure thereof incorporated by reference herein in its entirety.

### BACKGROUND

In radio communication systems, network design is influenced by factors such as communication range, maximum transmit power, receiver sensitivity, modulation and coding scheme, transmission frequency band, and channel bandwidth. To ensure that network performance criteria is met, cellular and mobile networks regularly consume large amounts of power particularly at the network infrastructure nodes that may contain many antenna elements and receive chains with little concern with respect to power consumption.

Although selectively reducing power consumption during times of network inactivity increases power conservation, these static techniques fail to consider dynamic behaviors of users, resulting in inefficient network management practices.

### SUMMARY

In general, one aspect disclosed features a system, comprising: one or more hardware processors; and one or more non-transitory machine-readable storage media encoded with instructions that, when executed by the one or more hardware processors, cause the system to perform operations comprising: obtaining key performance indictors (KPIs) and current configuration information for a radio access network (RAN) from equipment management services (EMS) of the RAN, the current configuration information describing a configuration of the RAN; generating latent space information by expanding the KPIs; and generating a configuration update for the RAN based on the current configuration information and the latent space information; and providing the configuration update to the EMS.

Embodiments of the system may include one or more of the following features. In some embodiments, generating latent space information comprises: applying the KPIs as input to a trained artificial intelligence (AI) model, wherein responsive to the input, the AI model outputs the latent space information, wherein the AI model has been trained with a training data set, and wherein the training data set includes (i) historical KPIs and/or historical latent space information and (ii) corresponding historical RAN configurations. In some embodiments, the operations further comprise: validating the AI model by applying a testing data set as input to the AI model, wherein the testing data set is different from the training data set, and determining an error rate by comparing a resulting output of the AI model with known genie values.

In some embodiments, the operations further comprise: retraining the AI model using additional training data sets responsive to the error rate exceeding a threshold value. In some embodiments, generating a configuration update comprises: providing a candidate RAN configuration; predicting energy that would be consumed by the RAN using the candidate RAN configuration based on the current configuration information and the latent space information; determining a supportable customer experience that would be provided by the RAN using the candidate RAN configuration based on the current configuration information and the latent space information; generating a RAN configuration that minimizes the energy that would be consumed by the RAN while providing the supportable customer experience; and generating the configuration update based on the generated RAN configuration.

In some embodiments, predicting energy that would be consumed by the RAN comprises: applying the current configuration information and the latent space information as input to a trained artificial intelligence (AI) model, wherein responsive to the input, the AI model outputs a prediction of the energy that would be consumed by the RAN using the candidate RAN configuration. In some embodiments, determining a supportable customer experience that would be provided by the RAN comprises: applying the current configuration information and the latent space information as input to a trained artificial intelligence (AI) model, wherein responsive to the input, the AI model outputs a determination of the supportable customer experience.

In general, one aspect disclosed features one or more non-transitory machine-readable storage media encoded with instructions that, when executed by one or more hardware processors of a computing system, cause the computing system to perform operations comprising: obtaining key performance indictors (KPIs) and current configuration information for a radio access network (RAN) from equipment management services (EMS) of the RAN, the current configuration information describing a configuration of the RAN; generating latent space information by expanding the KPIs; and generating a configuration update for the RAN based on the current configuration information and the latent space information; and providing the configuration update to the EMS.

Embodiments of the one or more non-transitory machine-readable storage media may include one or more of the following features. In some embodiments, generating latent space information comprises: applying the KPIs as input to a trained artificial intelligence (AI) model, wherein responsive to the input, the AI model outputs the latent space information, wherein the AI model has been trained with a training data set, and wherein the training data set includes (i) historical KPIs and/or historical latent space information and (ii) corresponding historical RAN configurations. In some embodiments, the operations further comprise: validating the AI model by applying a testing data set as input to the AI model, wherein the testing data set is different from the training data set, and determining an error rate by comparing a resulting output of the AI model with known genie values.

In some embodiments, the operations further comprise: retraining the AI model using additional training data sets responsive to the error rate exceeding a threshold value. In some embodiments, generating a configuration update comprises: providing a candidate RAN configuration; predicting energy that would be consumed by the RAN using the candidate RAN configuration based on the current configuration information and the latent space information; determining a supportable customer experience that would be provided by the RAN using the candidate RAN configuration based on the current configuration information and the latent space information; generating a RAN configuration that minimizes the energy that would be consumed by the RAN while providing the supportable customer experience; and generating the configuration update based on the generated RAN configuration.

In some embodiments, predicting energy that would be consumed by the RAN comprises: applying the current configuration information and the latent space information as input to a trained artificial intelligence (AI) model, wherein responsive to the input, the AI model outputs a prediction of the energy that would be consumed by the RAN using the candidate RAN configuration. In some embodiments, determining a supportable customer experience that would be provided by the RAN comprises: applying the current configuration information and the latent space information as input to a trained artificial intelligence (AI) model, wherein responsive to the input, the AI model outputs a determination of the supportable customer experience.

In general, one aspect disclosed features a computer-implemented method comprising: obtaining key performance indictors (KPIs) and current configuration information for a radio access network (RAN) from equipment management services (EMS) of the RAN, the current configuration information describing a configuration of the RAN; generating latent space information by expanding the KPIs; and generating a configuration update for the RAN based on the current configuration information and the latent space information; and providing the configuration update to the EMS.

Embodiments of the computer-implemented method may include one or more of the following features. In some embodiments, generating latent space information comprises: applying the KPIs as input to a trained artificial intelligence (AI) model, wherein responsive to the input, the AI model outputs the latent space information, wherein the AI model has been trained with a training data set, and wherein the training data set includes (i) historical KPIs and/or historical latent space information and (ii) corresponding historical RAN configurations. Some embodiments comprise validating the AI model by applying a testing data set as input to the AI model, wherein the testing data set is different from the training data set, and determining an error rate by comparing a resulting output of the AI model with known genie values; and retraining the AI model using additional training data sets responsive to the error rate exceeding a threshold value.

In some embodiments, generating a configuration update comprises: providing a candidate RAN configuration; predicting energy that would be consumed by the RAN using the candidate RAN configuration based on the current configuration information and the latent space information; determining a supportable customer experience that would be provided by the RAN using the candidate RAN configuration based on the current configuration information and the latent space information; generating a RAN configuration that minimizes the energy that would be consumed by the RAN while providing the supportable customer experience; and generating the configuration update based on the generated RAN configuration.

In some embodiments, predicting energy that would be consumed by the RAN comprises: applying the current configuration information and the latent space information as input to a trained artificial intelligence (AI) model, wherein responsive to the input, the AI model outputs a prediction of the energy that would be consumed by the RAN using the candidate RAN configuration. In some embodiments, determining a supportable customer experience that would be provided by the RAN comprises: applying the current configuration information and the latent space information as input to a trained artificial intelligence (AI) model, wherein responsive to the input, the AI model outputs a determination of the supportable customer experience.

### BRIEF DESCRIPTION OF THE DRAWINGS

The technology disclosed herein, in accordance with one or more various embodiments, is described in detail with reference to the following figures (hereafter referred to as “FIGs”). The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1A is a block diagram of the predictive network cell management system, according to one embodiment.

FIG. 1B is an illustration of an O-RAN network architecture, according to one embodiment.

FIG. 1C is an illustration of a non-ORAN network architecture, according to one embodiment.

FIG. 2A is an illustration of an example of a possible MIMO configuration, according to one embodiment.

FIG. 2B is an illustration of an example network design, according to one embodiment.

FIG. 3A is a block diagram of the predictive network cell management system, according to one embodiment.

FIG. 3B is a block diagram of the complex multi-dimensional surface mappers as a function of channel bandwidth, radio on/off status, MIMO configuration, and latent space for energy consumed (e.g., picojoules per received bit on the uplink, picojoules per received bit on the downlink, etc.), and consumer/customer experience (e.g., maximum latency, outage probability, minimum throughput, etc.).

FIG. 4 is an example block diagram for an rAPP predictive network cell management system within the O-RAN architecture, according to one embodiment.

FIG. 5 is an example block diagram for testing an rAPP predictive network cell management system within the O-RAN architecture, according to one embodiment.

FIG. 6A is a block diagram of an example process of training one or more of the AI/ML models disclosed herein, according to one embodiment.

FIG. 6B is a block diagram of an example process of testing one or more of the AI/ML models disclosed herein, according to one embodiment.

FIG. 7 is an illustration of an example method of: (i) using complex multi-dimensional surface mappers as a function of channel bandwidth, radio on/off status, MIMO configuration, and latent space for energy consumed, and (ii) consumer/customer experience as a function of channel bandwidth, radio on/off status, MIMO configuration, and latent space for use in recommending a RAN configuration according to a constraint optimization, according to one embodiment.

FIG. 8 illustrates an example computing system that may be used in implementing various features of embodiments of the disclosed technology.

### DETAILED DESCRIPTION

While massive MIMO has benefits and improves system coverage and capacity, the high power consumption remains a drawback. For example, Radio Unit (hereafter referred to as “RU”) power consumption increases as the number of active MIMO antennas increase. The high power consumption of massive MIMO systems has prevented massive MIMO from being widely adopted. In response, operators of MIMO systems have searched for methods of optimizing the power consumption of massive MIMO systems without sacrificing their superior performance.

Current methods disclosed in this description include mechanisms to optimize coverage and system capacity using intelligent antenna element management. For example, there is little benefit supporting MIMO functionality for all antenna elements in dense urban deployments where overlapping MIMO coverage likely exists. In this scenario, it is possible to turn off some of the antenna elements (due to the dense user distribution and likely overlap of MIMO beams) while still meeting network performance criteria. However, because RAN design is typically based on user density and does not take into account user behavior (e.g., indoor, slow mobility, fast mobility, etc.), switching antenna beams on and off can result in sub-optimal network configurations. For example, using a static or semi-static configuration based on time of day fails to consider the unpredictability of users' data usage and mobility, limiting performance of user equipment (hereafter referred to as “UE”) and system capacity in real-world dynamic environments.

Unfortunately, in real world scenarios, there is a lack of predictability regarding users' behavior and/or demand, making it difficult to manage network coverage without impacting the user's quality of service or system capacity. The network cell management system and MIMO mode selection methods proposed herein predict user behavior and/or demand and, based on that prediction, manage the overall RAN configuration.

In one embodiment, the network cell management system uses key performance indictors (hereafter referred to as “KPIs”) and cell fingerprinting to infer latent space information. The inferred latent space information is used by the network cell management system to recommend a cell configuration to reduce power consumption while continuing to meet network requirements. This is effectively a constrained optimization problem in which the goal is to minimize power consumption subject to the required performance constraints or network-operator chosen optimization criterion. In solving the constrained optimization problem, for example the system may provide an output or suggested RAN configuration that specifies the radio channel bandwidth, the number of radio bands to use, including the use of possible time division duplex (TDD)/frequency division duplex (FDD) band overlays, the number, type, and physical location of the transceiver radio streams that should be turned on, and the MIMO configuration that should be used that minimizes the power consumption, while still meeting the required network performance constraints or the network-operator's chosen optimization criterion, such as the maximum allowed outage probability, maximum throughput reduction, minimum energy saving, etc.

For non-MIMO deployments, the network cell management system may reduce transmission (hereafter referred to as “TX”) power for a specific cell by blocking/locking capacity cells to reduce network power consumption while still meeting the user's and the network's performance constraints. By selectively blocking/locking certain cells, the network cell management system is able to reduce power consumption without sacrificing network performance criteria (e.g., over-the-air channel bandwidth, number of transmit antennas, number of receive antennas, etc.). Typically, lower RF bands provide basic connectivity and cover the entire geographic cell across a wide coverage area, and high RF bands are typically overlayed to provide extra capacity at the targeted areas. However, since the design of the cell, including the selection of lower and overlayed bands was intended to provide adequate coverage and performance during peak utilization, for the average case, the cell is typically overdesigned. Thus it is possible to block or turn off certain RF bands (particularly the higher RF bands) in these over-designed cells to reduce network power consumption without sacrificing network performance, when peak performance is not needed.

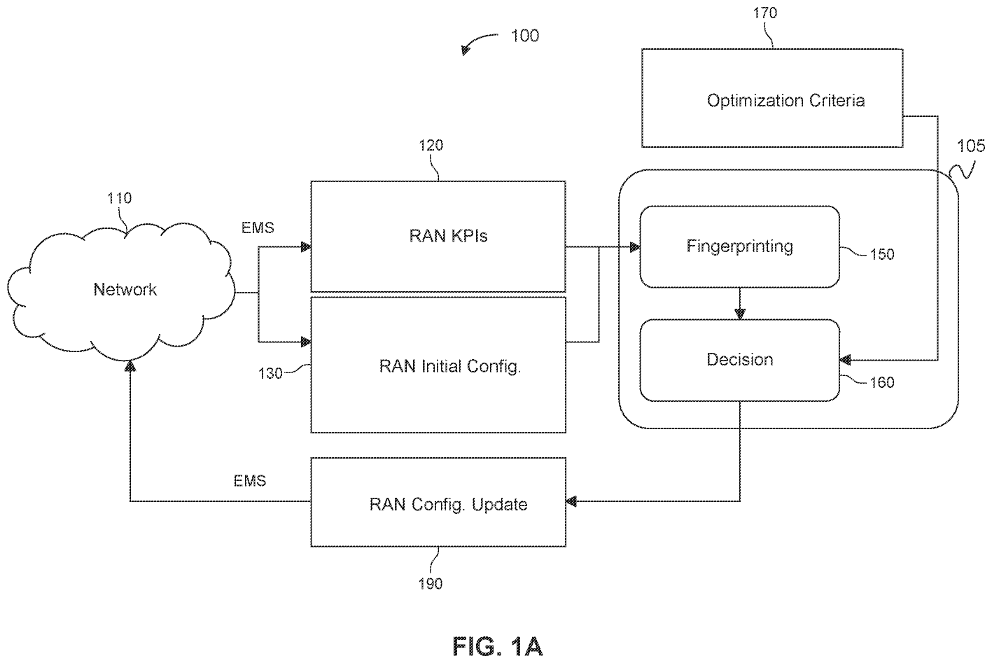

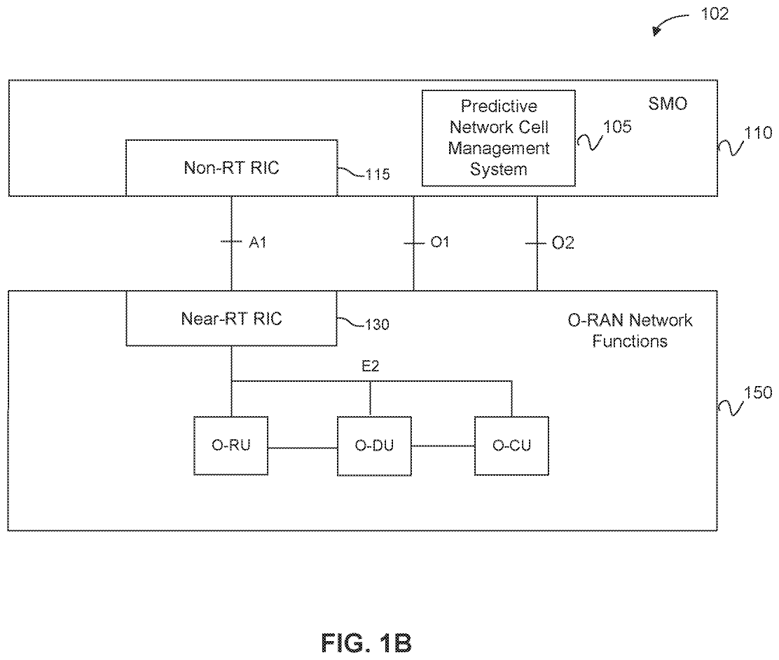

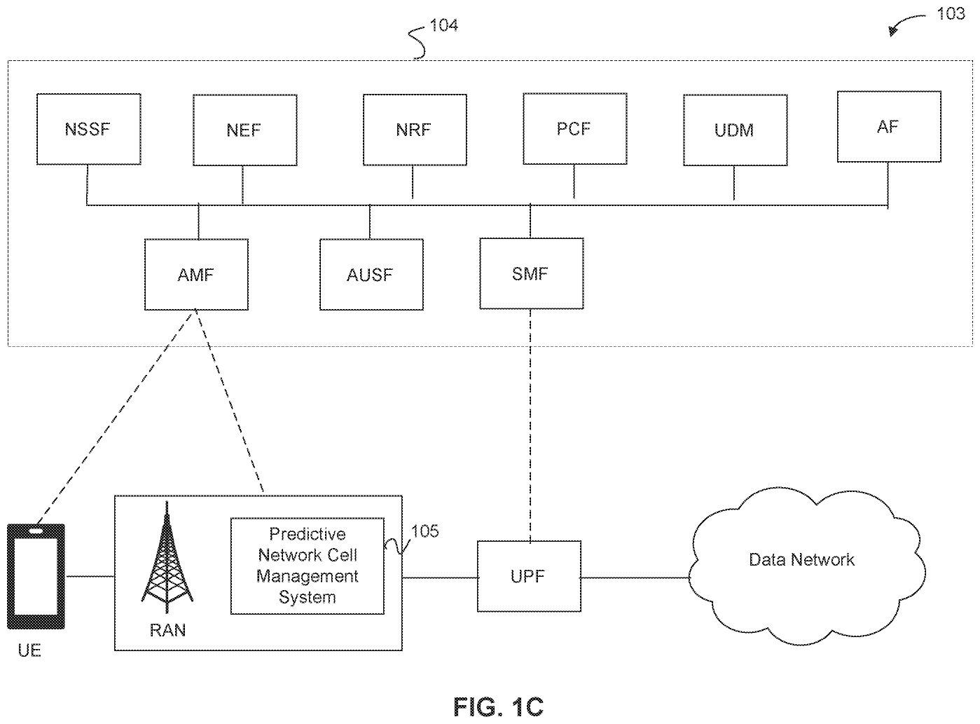

FIG. 1A is a block diagram of the predictive network cell management system 105, according to one embodiment. The example network architecture 100 includes a collection of RAN KPIs 120, the Initial or Current RAN Configuration 130, a network-operator provided optimization criteria 170 (optional), a predictive network cell management system 105 comprising a fingerprinting block 150, and a decision block 160 that returns back to the network a RAN Configuration Update 190 that updates the network's RAN configuration according to the output as determined by the predictive network cell management system 105.

The predictive network cell management system 105 uses a collection of RAN key performance indicators (“KPIs”), initial or current RAN configuration, and network-operator provided optimization criteria (optional) to determine the necessary RAN configuration to meet the required throughput, latency, and optionally the network operator optimization criterion to maintain an active network connection and sends back a RAN configuration update to the proprietary equipment management services (hereafter referred to as “EMS”) for implementation. In one embodiment, the predictive network cell management system 105 optimizes the overall RAN power consumption by proactively optimizing the RAN configuration (e.g., determining the number of active antenna elements in the advanced antenna array required to maintain network performance requirements).

By using the provided counters and KPIs, a ML trained fingerprinting block 150 can analyze and expand the KPIs to include latent or hidden space information, such as the number of users in each cell or sector and the mobility characterization of each user as indoor, pedestrian, or vehicular to get a more granular view of each cell. Based on the KPI information, the fingerprinting block 150 provides the network cell management system 105 with latent space information. The network cell management system 105 uses the latent space information and the RAN configuration as an input to the decision block 160 to provide a RAN Configuration update that meets the constrained optimization problem. The network cell management system 105 is discussed in further detail below.

The network cell management system 105 can be applied in both ORAN and non-O-RAN environments. For example, in an O-RAN network architecture, the network cell management system 105 may be applied as a rApp designed to run on a Non-Real Time RIC to realize different RAN automation and management use cases. In a non-O-RAN network architecture, the network cell management system 105 can be stored on the RAN as instructions that, when executed by one or more processors, cause a computing system to perform operations to collect RAN key performance indicators (“KPIs”), the initial or current RAN configuration, and network-operator provided optimization criteria (optional), and update the network's RAN configuration according to an output determined by the predictive network cell management system. In another embodiment in a non-O-RAN network architecture, the predictive network cell management system can be implemented in any of the 5G logical network nodes that provide an interface to receive the KPIs and the initial or current RAN configuration.

FIG. 1B is an illustration of an example O-RAN network architecture 102. The example O-RAN network architecture 102 includes a service management orchestration component 110 (hereafter referred to as “SMO”) that oversees all orchestration, management and automation of RAN elements. The SMO 110 can support O1, A1 and O2 interfaces. The following disclosures of O-RAN network architectures and elements are incorporated herein by reference in their entirety: O-RAN.WG1 Use Cases and Overall Architecture Workgroup; O-RAN.WG2 Non-Real Time RAN Intelligent Controller and A1 Interface Workgroup; O-RAN.WG3 Near-Real Time RIC and E2 Interface Workgroup; O-RAN.WG5 Open F1 W1 E1 X2 Xn Interface Workgroup, O-RAN.WG6 Cloudification and Orchestration Workgroup, O-RAN.WG7 White-box Hardware Workgroup, O-RAN.WG8 Stack Reference Design Workgroup, O-RAN.WG9 Open X-Haul Transport Workgroup, O-RAN.WG10 OAM for O-RAN, O-RAN.WG11 Security Work Group. In addition, the technical specification disclosed in the 2022 O-RAN Test and Integration Focus Group Certification and Badging Processes and Procedures is incorporated herein by reference in their entirety. The SMO 110 includes a network cell management system 105 and a Non-Real Time RAN Intelligent Controller 115 (hereafter referred to as a “Non-RT RIC”). The Non-RT RIC 115 is part of the SMO 110, and is centrally deployed in the service provider network, which enables Non-Real Time control of RAN elements and their resources through specialized applications called rAPPs.

The O-RAN network architecture 102 further includes O-RAN Network Functions 150 comprising a Near-Real-Time RAN Intelligent controller 130 (hereafter referred to as a “Near-RT RIC”), an O-Ran Central Unit (hereafter referred to as “O-CU”), O-RAN Distributed Unit (hereafter referred to as “O-DU”) and O-RAN Radio Unit (hereafter referred to as “O-RU”). The Near-RT RIC 130 resides within a telco edge cloud or regional cloud and is responsible for intelligent edge control of RAN nodes and resources. The Near-RT RIC 130 controls RAN elements and their resources with optimization actions that typically have latency requirements in the range of 10 milliseconds or less. The Near-RT RIC 130 receives policy guidance from the Non-RT RIC 115 and provides policy feedback to the Non-RT RIC 115 through specialized applications called xAPPs. The Non-RT RIC 115 and Near-RT RIC 130 offers frameworks to specific applications (e.g., rAPPs for Non-RT RIC and xAPPs for Near-RT RIC) to be integrated into RICs with minimum effort, enabling different contributors to provide particular applications for problems within their domain of expertise that was not possible in legacy closed systems.

The O-CU is logical node configured to host RRC, SDAP and PDCP protocols. The O-CU includes two sub-components O-RAN Central Unit-Control Plane (hereafter referred to a “O-RAN CU-CP”) and an O-RAN Central Unit-User Plane (“O-RAN CU-UP”). The O-RU is a logical node hosting Low-PHY layer and RF processing based on a lower layer functional split. The O-DU a logical node hosting RLC/MAC/High-PHY layers based on a lower layer functional split.

FIG. 1C is an illustration of a non-O-RAN network architecture 103, according to one embodiment. In this embodiment, the non-O-RAN network architecture 103 includes a 5G network architecture comprising the predictive network cell management system 105. The 5G network architecture includes two main components: (i) radio access networks (RAN), and (ii) a core network 104. The core network 104 includes a plurality of network functions (“NFs”), such as an Access and Mobility Management Function (“AMF”). The AMF implements logic necessary to provide access and mobility functions to the UE. Non-limiting examples of NFs include: (i) a Session Management Function (SMF) to create, update, and remove PDU sessions while also managing session context with UPF, UE IP address allocation and DHCP role, (ii) a Network Repository Function (NRF) to maintain updated records of services provided by other NFs, (iii) a Policy Control Function (PCF) comprising unified policy framework to govern network behavior, and provide policy rules for a control plane, (iv) Unified Data Management (UDM) to generate authentication credentials, and authorize access based on subscription data; (v) an Application Function (AF) to interface with 3GPP core networks to traffic routing preferences NEF access, policy framework interactions, and IMS interactions, (vi) a Network Exposure Function (NEF) to securely open up the network to third-party applications, an Authentication Server Function (AUSF) to authenticate 3GPP access and untrusted non-3GPP access, and (vii) a network slice selection function (NSSF) to select network slice instances for the UE, and determine the AMF set to serve the UE. In an embodiment, the predictive network cell management system 105 can be implemented in any suitable network function logical node.

The 5G core network architecture, as defined by 3GPP, utilizes cloud-aligned, service-based architecture (SBA) that spans across all 5G functions. The 5G core network emphasizes virtualized software functions deployed using MEC infrastructure. As seen in FIG. 1C, the RAN may include the predictive network cell management system 105. The RAN can include a disaggregated, flexible or virtual RAN. For example, in FIG. 1C, the RAN communicates with the: (i) UE, (ii) AMF, and a (iii) User Plane Function (UPF).

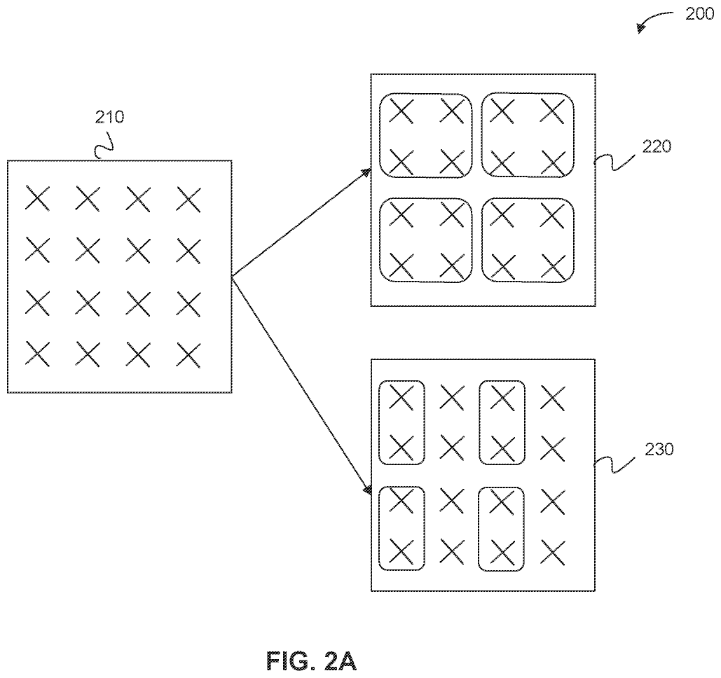

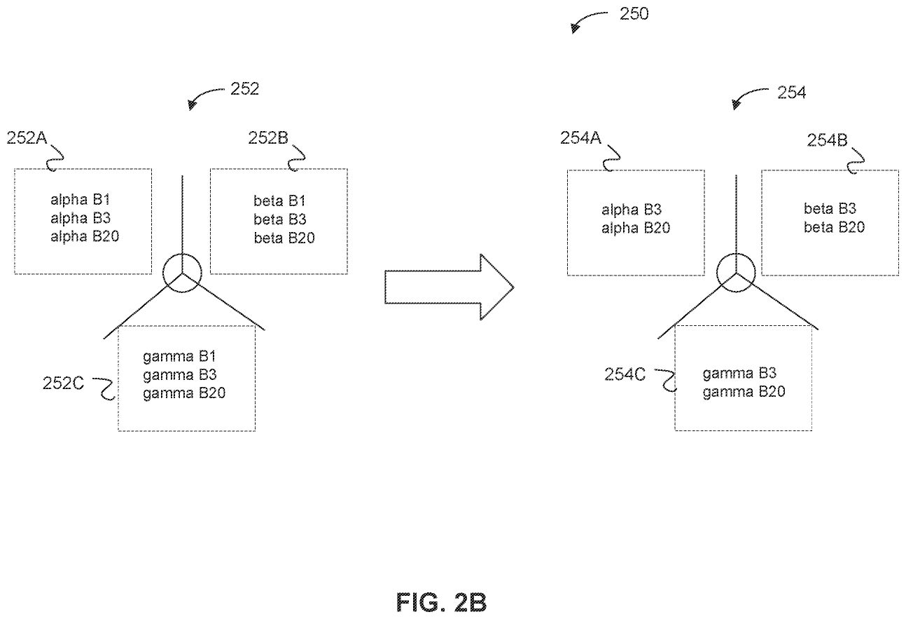

FIG. 2A is an illustration of an example MIMO deployment 200. The example MIMO deployment 200 includes an antenna array 210 comprising 32 cross-polarized (not necessarily required) antenna elements for both transmission and reception. The use of an antenna array with a high number of antenna elements is to enable antenna beams with high gain and to support the ability to steer beams as necessary to constructively add or combine the signals from several antenna elements at the receiver. Beam steering may be accomplished through individually controlling the amplitude and/or phase of the antenna elements. The antenna array may also be divided into subarrays where the control of the amplitude and/or phase may be applied on a subarray basis. For example, antenna array 210 may be partitioned into subarrays of 8 cross-polarized antenna elements as depicted in 220 to support for example 4 UEs. As the scenario and usage pattern of the UEs changes dynamically due to changes in traffic patterns, mobility, or location, in some instances an even lower number of antenna elements may be sufficient to support the desired beam shape and antenna gain needed to meet the required link budget and required SINR of the system. For example, the antenna array 210 may change the configuration of each sub-array to be only 4 cross-polarized antenna elements as depicted in 230, as opposed to the original 8 cross-polarized antenna elements in 220.

Because conventional mobile network designs are based on the number of UEs within a defined region, conventional mobile network designs struggle during variations in cell utilization. Often, changes in UEs (e.g., traffic patterns, mobility, location) situations arise where a lower number of antenna elements can sufficiently address the required beam shape, gain to meet the link budget and the SINR of the system, resulting in unnecessary redundancy in network coverage. By deactivating extra antenna elements, the network can reduce its power consumption while still meeting UE requirements. For example, as seen in sub-array configuration 230, the antenna array 210 can properly serve 4 UEs using only 4 elements for each UE, and can thus power off 16 antenna elements with commensurate reductions in power consumption.

However, determining the optimal power consumption is difficult since throughput demands of the cell vary with time and antenna settings cannot be changed too frequently. The predictive network cell management system proposed herein solves this problem by using machine learning (hereafter referred to as “ML”) to predict demand and choose RAN configuration and MIMO settings that optimizes for the lowest power consumption while meeting network performance constraints or network-operator chosen optimization targets.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as effective as possible under the given circumstances, or making or achieving performance better than that which can be achieved with other settings or parameters.

FIG. 2B is an illustration of an example network design 250, according to one embodiment. The example network design 250 includes a three-sectored cell site 252, consisting of sectors alpha 252A, beta 252B, and gamma 252C. Each sector supports up to 3 RF bands that can be used for communication. For example, each sector can use bands B1, B3, and B20. Initially, the cell configuration 252 is meant to support 100 UEs with a target throughput of 5 Mbps where the 100 UEs are distributed according to the following profile: 98 indoor, 1 pedestrian, 1 vehicular. For example, to support this mix of UEs and the target throughput all 3 sectors must use all three bands: B1, B3, and B20. Subsequently, cell configuration 254 is meant to support 100 UEs with a target throughput of 5 Mbps where the 100 UEs are distributed according to the following profile: 5 indoor, 5 pedestrian, and 90 vehicular. For example, to support this mix of UEs and the target throughput, the three sectors need only to use bands B3 and B20, allowing band B1 to be shut down, enabling a reduction in power consumption.

Additional examples are provided in Table 1, Table 2 and Table 3 below. As seen in Table 1 below, in a 9 site configuration at 9 Km², stationary throughput gain in a 2 band example can be increased by approximately 5 percent when compared to 3 bands for the same number of UEs.

TABLE 1

| | | | |
|---|---|---|---|
| Indoor | Pedestrian | Car | Average Throughput (Mbps) |

3 Bands

| | | | |
|---|---|---|---|
| 98 | 1 | 1 | 4.80 |
| 5 | 5 | 90 | 3.78 |

2 Bands

| | | | |
|---|---|---|---|
| 98 | 1 | 1 | 4.55 |
| 5 | 5 | 90 | 3.75 |

As seen in Table 2 below, in a 9 site configuration at 16 Km², stationary throughput gain in a 2 band example can be increased by approximately 15 percent when compared to 3 bands for the same number of UEs.

TABLE 2

| | | | |
|---|---|---|---|
| Indoor | Pedestrian | Car | Average Throughput (Mbps) |

3 Bands

| | | | |
|---|---|---|---|
| 98 | 1 | 1 | 3.44 |
| 5 | 5 | 90 | 4.00 |

2 Bands

| | | | |
|---|---|---|---|
| 98 | 1 | 1 | 2.92 |
| 5 | 5 | 90 | 3.99 |

As seen in Table 3 below, in an 18 site configuration at 16 Km², stationary throughput gain in a 2 band example can be increased by approximately 10 percent when compared to 3 bands for the same number of UEs.

TABLE 3

| | | | |
|---|---|---|---|
| Indoor | Pedestrian | Car | Average Throughput (Mbps) |

3 Bands

| | | | |
|---|---|---|---|
| 98 | 1 | 1 | 3.87 |
| 5 | 5 | 90 | 4.60 |

2 Bands

| | | | |
|---|---|---|---|
| 98 | 1 | 1 | 3.47 |
| 5 | 5 | 90 | 4.54 |

Referring again to FIG. 1A, the cellular network 110 consists of the various components necessary to support a cellular wireless network, that are typically controlled and report information via the EMS. The example network architecture 100 includes a collection of RAN key KPIs 120, the Initial or Current RAN Configuration 130, a network-operator provided optimization criteria 170 (optional), a predictive network cell management system 105 comprising a fingerprinting block 150, a decision block 160, that returns back to the network a RAN Configuration Update 190 that updates the network's RAN configuration according to the output as determined by the predictive network cell management system 105.

As seen in FIG. 1A, the cellular network is managed and configured via a RAN Equipment Management System. The Equipment Management System manages functions and capabilities of network elements on the network element-management layer of a telecommunications management network model. The Equipment Management System provides access to RAN KPIs and the initial and/or current RAN configuration. The operator and the network equipment defines the KPIs and their granularity. The RAN configuration is a set of system-level configurations defined at the cell and possibly sector level and maintained by the Equipment Management System. In some embodiments, the network operator may also provide an optimization criterion, including service level agreement margins and desired energy-saving percentages to the module as inputs. In some embodiments, the service level agreements for networks may support slice-based services—for each slice, different service level agreements can be defined and implemented.

Prediction is based, at least in part, on real-time RAN KPIs received from the operator network RAN trace feed (e.g., by data collectors) and sent to the fingerprinting block 150 to find latent space information. KPIs can include, but are not limited to user-specific initial scheduling delay, MAC (Medium Access Control) delay, and RLC (Radio Link Control) delay for the duration of the session. Other KPIs include PDCP (Packet Data Convergence Protocol) layer user-specific PDCP throughput and PDCP PDU (Protocol Data Unit) loss rate for the session duration. Yet even more KPIs may reflect user-specific RLC PDU error rate percentage, triggered by RLC ARQ NACKs (automatic repeat request negative acknowledgements) and total number of RLC SDUs (service data units) for the duration of the session. Other KPIs may include MAC layer statistics such as user-specific MAC PDU error rate percentage (triggered by MAC HARQ NACKs), total number of MAC HARQ transmissions, total number of successful MAC HARQ transmissions modulated with QPSK, 4 QAM, 16 QAM and 64 QAM, and total size of MAC PDUs transmitted for the session. Other KPIs may include physical (PHY) layer statistics such as periodic logging of user-specific RSRP (reference signal received power) and RSRQ (reference signal received quality throughout the duration of the session). KPIs may also include cell-level KPIs that correspond to periodic logging of the number of active user RRC (radio resource control) connections on the cell, the PRB (physical resource block) utilization of the cell, and power consumption. KPIs may also include the number of connected and/or admitted RRC connections. KPIs may also include information regarding the target throughput and/or latency of the connected and/or admitted RRC connections. The initial and/or current RAN configuration may include such parameters as channel bandwidth, bands, type of duplexing on those bands (TDD/FDD), MIMO configuration, number of attached users, requested throughput, etc.

In one embodiment, the predictive network cell management system 105 optimizes the overall RAN power consumption by proactively optimizing the RAN configuration including for example, the number of active antenna elements in the advanced antenna array. The predictive network cell management system 105 determines the necessary RAN configuration to meet the required throughput, latency, and optionally the network operator optimization criterion to maintain an active network connection and sends back a RAN configuration update to the EMS for implementation. The predictive network cell management system 105 may be a remote system. For example, the predictive network cell management system 105 may be a cloud based system. The cloud based system can include a server and processor remote from the antenna arrays.

By using the provided counters and KPIs 320, a ML trained fingerprinting block 150 can analyze the KPIs and expand the KPIs to include latent or hidden space information, such as the number of users in each cell or sector that indoor, pedestrian, and vehicular to get a more granular view of each cell. In one embodiment, the latent or hidden space information can include one or more of: (i) UE profile information comprising mobility type (e.g., indoor, slow (pedestrian) and fast (vehicular) mobile), and (ii) data usage profile (e.g., light, medium, and heavy). The examples listed above should be interpreted as non-limiting.

Based on the KPI information, fingerprinting block 150 will provide the network cell management system 105 with latent space information. The network cell management system 105 uses the latent space information and the RAN configuration as an input to the decision block 160 to provide a RAN Configuration update that meets the constrained optimization problem. Because the RAN configuration update is being applied to an operational network, the RAN Configuration update cannot be “tested” without potentially adversely affecting the current UEs in the system. In other words, a classic negative feedback control loop that is critically damped to avoid oscillatory behavior is not possible to use in an operational network, thus other optimization and control techniques such as AI/ML models must be used that will prevent the network from becoming unstable, and/or unable to provide minimum levels of service.

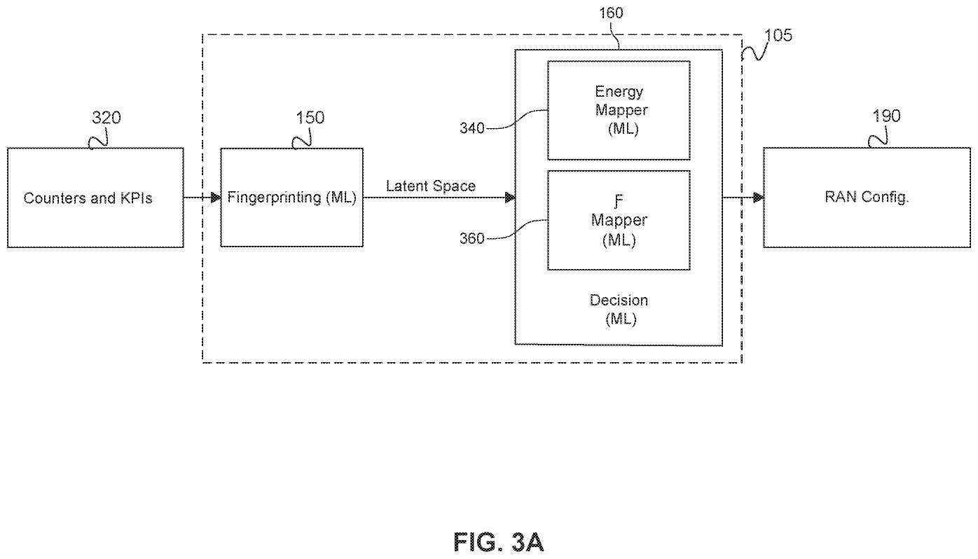

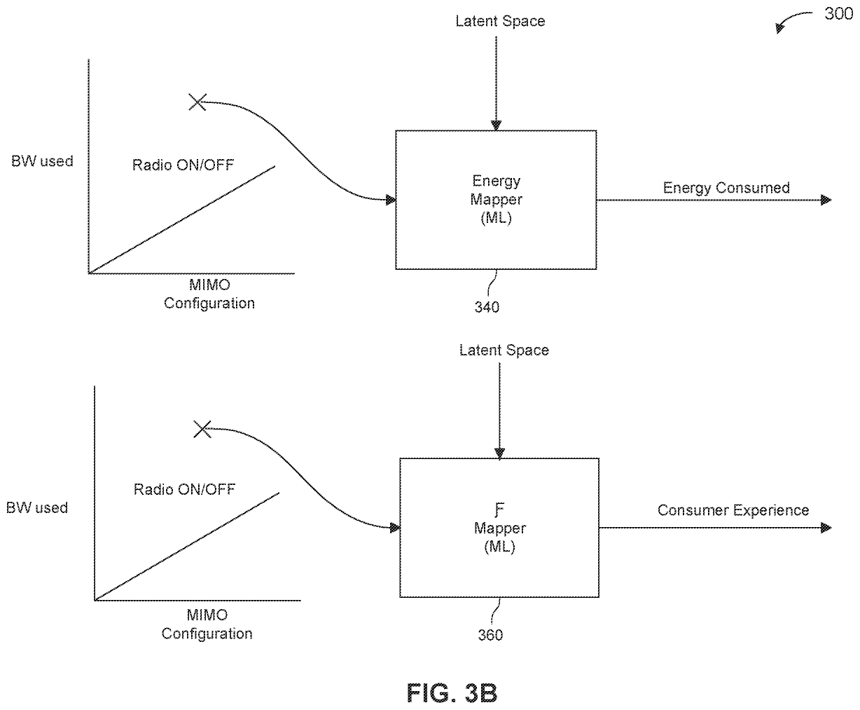

AI/ML models can be utilized to identify and learn the most salient information for differentiating cell-level KPIs. For example, AI/ML models can be used to predict cell-level KPIs, given input noisy high-dimensional time sequence data. Because the RAN configuration update is a very complex multidimensional function of the KPIs, initial or current RAN configuration, latent (hidden) space expansion, and optionally the network-operator provided optimization criterion, typical optimization techniques are not tractable. Thus, using AI/ML models to model the complex surfaces as a function of these inputs is needed. As explained in further detail in FIG. 3A, both the energy consumed and the supportable consumer experience metrics are also a very complex multidimensional function of the KPIs, initial or current RAN configuration, latent (hidden) space expansion, and optionally the network-operator provided optimization criterion.

Referring back to FIG. 1A, in one embodiment, the plurality of cell-level KPIs are processed by a first AI model configured to determine a cell-level KPI fingerprint. The cell-level fingerprinting is not limited to a single AI model. For example, in some configurations, the cell-level KPI fingerprinting can be processed by a first AI model and a second AI model. The first AI model and second AI model may process data in parallel or sequentially. Each AI model is trained using training data sets. The training can be performed wholly on the system, or in part, e.g., with a remote/cloud infrastructure. In some embodiments, the training may be performed using additional data sources or via a pre-generated neural network. The neural network parameters can be modified or optimized based on the observation by the fingerprinting block 150 of an error rate. In one embodiment, the process of optimizing the neural network parameters may be transformed into a closed loop. For example, in the closed loop, the neural network parameters continue to be processed and updated by the fingerprinting block 150 as the AI model approaches a low error rate.

The one or more KPI fingerprinting AI models can be stored on one or more non-transitory computer readable media configured to collectively store instructions that, when executed by one or more processors, cause a computing system to perform operations. The operations can include obtaining, by the computing system, one or more network signals, processing, by the computing system, the network signals with a first machine-learned model to determine a device fingerprint based at least in part on the one or more network signals and generate a first classification for a first signal. In some configurations, the operations can include processing, by the computing system, the device fingerprint with a second machine-learned model to generate a second classification for a second signal.

In some configurations, fingerprinting can be applied to UEs using samples taken from a physical layer of the network (e.g., hardware). In one embodiment, the fingerprinting block 150 can identify a UE based on higher-level characteristics, such as, for example, medium address control (MAC) addresses, IP addresses, etc. In this configuration, the system receives radio signals from a plurality of radio sources located at a given location as an indoor fingerprint signature of the location. The signature may be represented as a parameter, a vector, a map, an image, or a combination thereof, by the system. The fingerprinting block 150 is configured to obtain a first training data set (e.g., measured radio fingerprint data) associated with measurements of strength of received radio signals transmitted by the UEs for the location. The fingerprinting block 150 then determines, for one or more of the radio sources for the location, a statistical distribution model (e.g., means and variance) of the measured data in the first data set and generates a second training data set from the first training data set via an extrapolation operation. That is, the system may use all of the radio sources that exist at a given location.

FIG. 3A is a block diagram of the predictive network cell management system 105, according to one embodiment. The predictive network cell management system 105 includes the fingerprinting block 150 and the decision block 160. Here, the decision block includes an Energy Mapper block 340 and a Function Mapper block 360. Both the Energy Mapper block 340 and the Function Mapper block 360 use latent space information generated by the fingerprinting block to determine the optimal network configuration and are trained using an AI/ML algorithm as described above. As described in further detail in FIG. 3B, the Energy Mapper block 340 uses the latent space information along with the RAN configuration including for example at least the channel bandwidth, the number of antenna elements that are powered on, and/or the MIMO configuration to determine the energy consumed. The Function Mapper block 360 uses the latent space information along with the RAN configuration including for example at least the channel bandwidth, the number of antenna elements that are powered on, and/or the MIMO configuration to determine the “consumer experience.” As used herein, consumer experience refers to the network constraints required to provide UEs with network coverage. The consumer experience can be based on one or more factors, such as channel bandwidth, latency, etc. In an embodiment, the consumer experience may be based on the minimum network constraints required to provide network coverage. In another embodiment, the consumer experience may be based on the optimal customer experience. As previously described herein, optimal can be used to mean making or achieving performance as effective or perfect as possible. Here, consumer experience is meant to entail and cover all metrics observable and agreed upon for example, in a services level agreement (“SLA”). Non-limiting examples of SLA metrics may include one or more of: (i) average user throughput, (ii) average user delay and (iii) average user jitter.

In one embodiment, both the Energy Mapper block 340 and the Function Mapper block 360 include AI models. The AI models may be used to identify and learn the energy consumed and desired consumer experience. For example, one or more AI models can be used by the Energy Mapper block 340 to determine the energy consumed, given the latent space information provided to one or more AI models by the fingerprinting model 150. For example, one or more AI models can be used by the Function Mapper block 360 to determine the consumer experience, given the latent space information provided to one or more AI models by the fingerprinting model 150. The AI models can be stored on one or more non-transitory computer readable media configured to collectively store instructions that, when executed by one or more processors, cause a computing system to perform operations. The operations can include determining, by the computing system the energy consumed and the consumer experience, and processing, by the computing system, latent space information with a first machine-learned model and a second machine-learned model to determine the energy consumed and customer experience.

Each AI model disclosed herein can be built using the same or different ML methods. Non-limiting examples of ML methods include supervised learning classification methods (e.g., Naïve Bayes Classifier algorithms, Support Vector Machine Algorithms, Logistic Regression, Nearest Neighbor, etc.), unsupervised learning clustering methods (e.g., K Means Clustering Algorithms), supervised learning/regression models (e.g., Linear Regression, Decision Trees, Random Forests, etc.) and reinforcement learning (e.g., Artificial Neural Networks). The ML methods may include various neural network architectures. For example, the various neural network architectures can include deep neural networks such as a convolutional neural networks (hereafter referred to as “CNNs”) or a residual neural networks (hereafter referred to as “RESNET”). The various neural networks architectures are not limited to a specific number of layers, and can comprise any number of layers. In one configuration, the latent space data is processed by a first AI model configured to determine the energy consumer and by a second AI model configured to determine the consumer experience. The first AI model and second AI model may process data in parallel or sequentially. Although the previous configuration disclosed a first AI model for determining energy consumed and a second AI model for determining the consumer experience, the Energy Mapper block 340 and Function Mapper block are not limited to a single AI model. For example, in some configurations, the latent space information can be processed by a first AI model and a second AI model configured to determine the energy consumer, or a first AI model and second AI model configured to determine the consumer experience. Each AI model is trained using training data sets. The training can be performed wholly on the system, or in part, e.g., with a remote/cloud infrastructure. In some embodiments, the training may be performed using additional data sources or via a pre-generated neural network. The neural network parameters can be modified or optimized based on the observation by the fingerprinting block 150 of an error rate. In one embodiment, the process of optimizing the neural network parameters may be transformed into a closed loop. For example, in the closed loop, the neural network parameters continue to be processed and updated by the fingerprinting block 150 as the AI model approaches a low error rate.

FIG. 3B is a block diagram of a optimization option 300 subject to a constraint, according to one embodiment. The objective of the constrained optimization is to minimize the energy consumed subject to the constraint that the network objective function is met. The energy consumed can be based on one or more RAN configurations (e.g., network factors). A non-exhaustive list of relevant RAN configuration network factors can include at least one of: (i) channel bandwidth used, (ii) which radio transceiver chains are powered on, (iii) the MIMO configuration. The network objective function can be multidimensional and include a plurality of network criteria. A non-exhaustive list of objective functions can include at least one of: (i) outage probability, (ii) minimum supported throughput, and (iii) and frame error rate. For example, an objective function may be an outage probability of less than about 0.01%, and/or a minimum supported throughput of about 1600 Mbps (e.g., 977 bits×273 RBs×1600 slots×4 layers/1024/1024=1600 Mbps) and/or a frame error rate of less than some predetermined threshold.

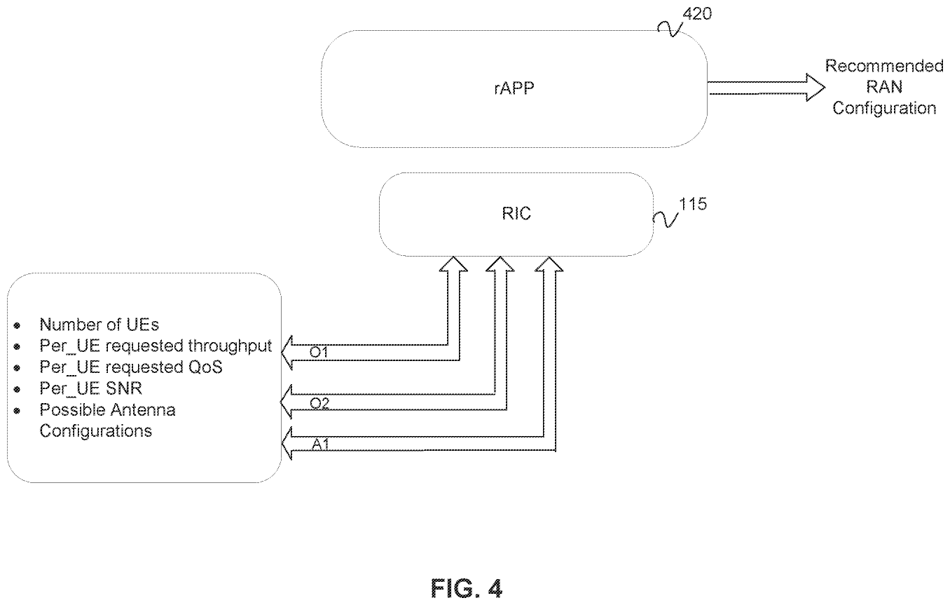

FIG. 4 is an example block diagram for an rAPP that implements the network cell management system described herein in an O-RAN network structure, according to one embodiment. The block diagram includes the network cell management system rAPP 420, the Non-RT RIC 115, and a plurality of interfaces comprising the O1 interface, the A1 interface and the O2 interfaces where the KPI and initial and/or current RAN configuration may be communicated to the RIC.

The network cell management system rAPP 420 is configured to receive contextual RAN information and KPIs such as channel quality indicators (hereafter referred to as “CQI”) primarily through the A1 and O1 interfaces. Non-limiting examples of information received by the A1 interface include: (i) throughputs, (ii) modulation and (iii) coding scheme (hereafter referred to as “MCS”), (iv) quality of service (hereafter referred to as “QoS”) served, (v) signal interference and (vi) noise ratio (hereafter referred to as “SINR”). Non-limiting examples of information received by the O1 interface include current and possible MIMO configurations. In an embodiment, the network cell management system rAPP 420 is configured to run on the Non-RT RIC 115 and suggests a RAN configuration including MIMO recommendations to the RU via the O1 interface and to the core.

The network cell management system rAPP 420 can also be utilized in non-O-RAN 5G networks. In non-O-RAN networks, the mobile operator provides an application programming interface (“API”) to the network cell management system as a module that runs on a remote server and/or cloud. Through the API, data at the cell level, including KPIs can be provided to the remote cloud-based network cell management cell system. The network cell management system returns to the EMS via the API an updated RAN configuration as described herein.

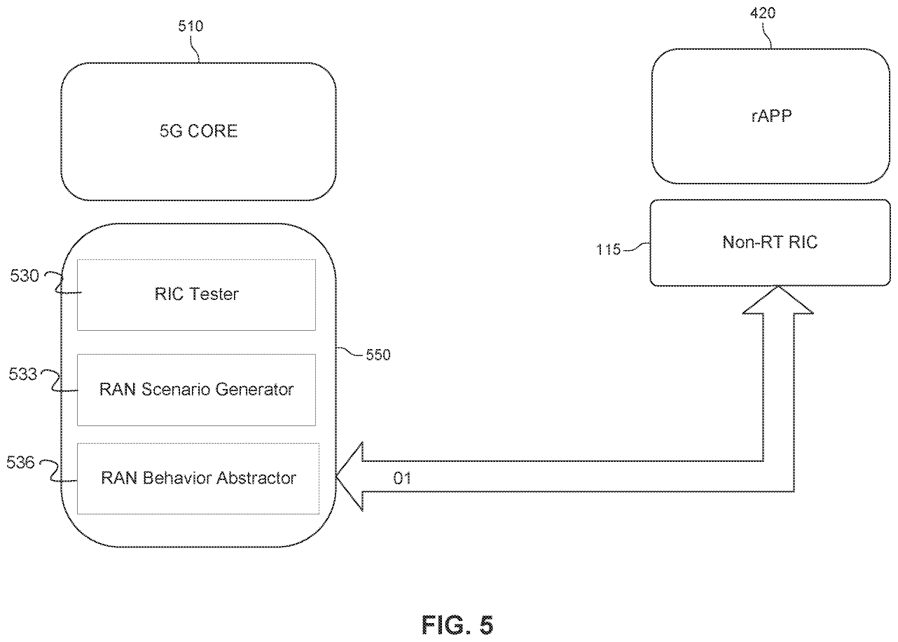

FIG. 5 is an illustration of a block diagram for testing the rAPP 420, according to one embodiment. FIG. 5 includes a 5G core 510, a RIC tester core 550, the Non-RT RIC 115 and the network cell management system rAPP 420. The RIC tester core 550 includes a RIC tester 530, a RIC scenario generator 533, and a RAN behavior abstractor 536. The RIC tester core 550 is connected to the Non-RT RIC 115 via an O1 interface.

In one embodiment, the RIC tester 530 includes an O-DU simulator (not shown), an UE simulator (not shown) and an O-CU simulator (not shown). The UE simulator can be communicatively coupled to the O-DU simulator. The O-DU simulator is coupled to the O-CU simulator. In this embodiment, the RIC tester 530 is configured to emulate the O-DU, O-CU and RAN network. The RIC tester 530 can be connected to the Near-RT RIC 130 via an E2 interface. In this configuration, the Near-RT RIC 130 is connected to the Non-RT RIC 115 via an A1 interface.

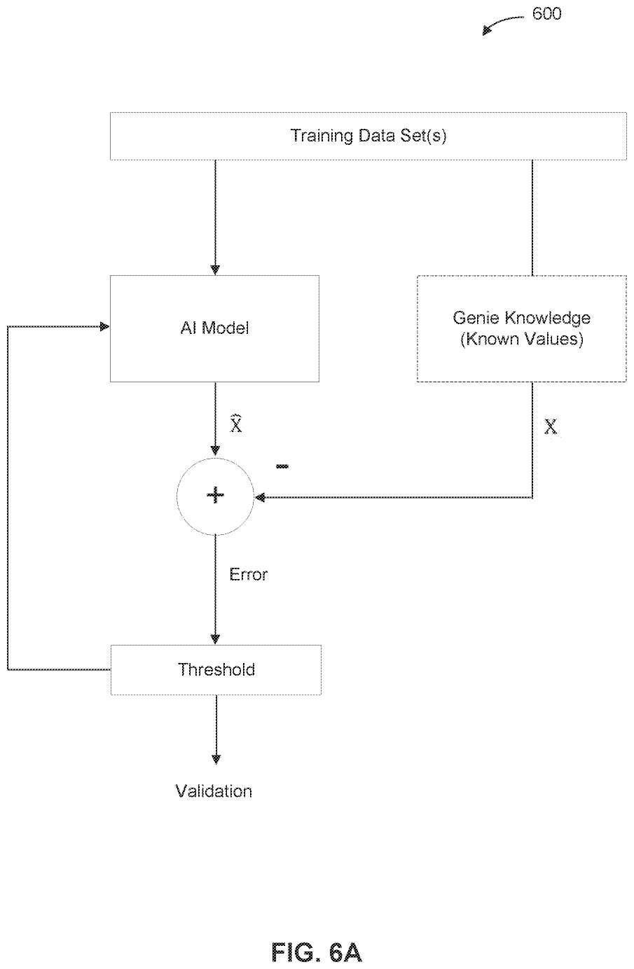

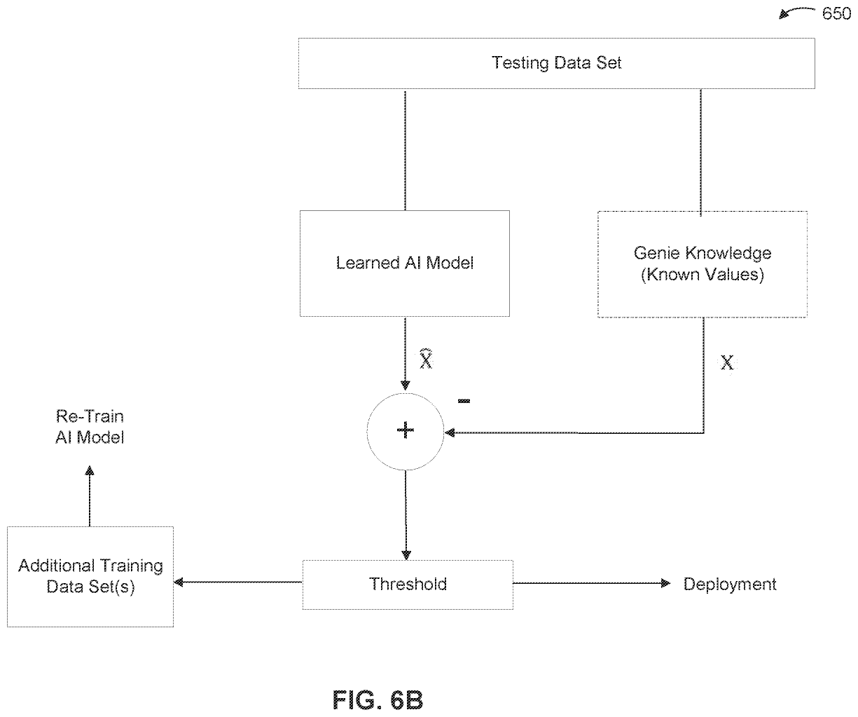

FIG. 6A is a block diagram of an example process 600 of training the AI models disclosed herein, according to one embodiment. The AI models include the fingerprinting AI model 150, the Energy Mapper AI model 340 and the Function Mapper AI model 360. Training of the AI models can be performed wholly on the system, or in part, e.g., with a remote/cloud infrastructure. Training each AI model includes inputting one or more training data sets into the AI model. For example, training data simulating realistic RAN scenarios may be used to as inputs to train the AI model. Examples of training data are included in Table 4 below.

TABLE 4

| | |
|---|---|
| Channel Classification | Average classification of the cell over the past month, e.g., |
| | urban macro, urban micro, rural, etc. |
| Mobility of UEs | Average Speeds of UE in the cell over the past month |
| Number of UEs attached to a | Historical data over the past month, with at least hourly |
| cell/sector | resolution or higher |
| Data rates of those UEs | Historical data over the past month, with at least hourly |
| | resolution or higher |
| SNRs of those UEs | Historical data over the past month with at least hourly |
| | resolution or higher |

The one or more training data sets are used by the AI model to generate a decision \hat{X}. The decision \hat{X} is compared to the known Genie values X to determine an error. The genie known values X may be a known decision for the training data set. If the error rate is less than a threshold value, the AI model is validated (e.g., tested) using testing data. If the error rate is greater than a threshold value, the AI model is retrained using the error to adjust one or more parameters of the one or more AI/ML methods. For example, the AI/ML model for the Energy Mapper during the training phase may be as inputs the latent space information and a given RAN configuration and will output the predicted energy consumed based on its current model. The same latent space information and RAN configuration may also be obtained from a real-world network or simulated network, and the actual or simulated energy consumed may be used as the reference genie data for the AI/ML model training.

In one embodiment, the training data set includes RAN KPIs and the initial and/or current RAN configuration. The operator and the network equipment defines the KPIs and their granularity. By using the provided counters and KPIs, a AI/ML fingerprinting model can be trained to analyze the KPIs and expand the KPIs to include latent space information. The decision made by the AI/ML fingerprinting model can be compared to a real world decision to determine an error rate. If the AI/ML fingerprinting model scores beneath an threshold error rate (e.g., the AI/ML fingerprinting model incorrectly predicted the real world decision), then the AI/ML fingerprinting model can be re-trained via a feedback loop.

In one embodiment, the training data set includes a latent hidden space expansion and RAN configuration. The latent hidden space expansion and RAN configuration can be used by the Energy Mapper AI model 340 and the Function Mapper AI model 360 to determine the energy consumed and the supportable consumer/customer experience SLAs for a given candidate RAN configuration.

FIG. 6B is a block diagram of an example process of validating the AI/ML models disclosed herein, according to one embodiment. Validating the AI models 610 includes inputting a testing data set 650 different from the training data set into the trained AI/ML model. The testing data set 650 can include one or more sets of data disclosed in Table 4 as training data. The testing data set 650 is used by the AI/ML model to generate a decision \hat{X}. The decision \hat{X} is compared the genie known values X to determine an error rate. If the error rate is less than a threshold value, the AI model is deployed. If the error rate is greater than a threshold value, the AI model is re-trained using additional training data sets. The re-training procedure can mirror the training procedure described in FIG. 6A.

For example, if the Fingerprinting AI model incorrectly identifies the most salient information for differentiating cell-level KPIs (e.g., incorrectly predicts level KPIs, given input noisy high-dimensional time sequence data), then the AI fingerprinting model can be re-trained using additional training data. For example, if the Energy Mapper AI model incorrectly determines the energy consumed for a given candidate RAN configuration, then the Energy Mapper AI model can be re-trained using additional training data. For example, if the Function Mapping AI model incorrectly determines the consumer/customer experience SLAs for a given candidate RAN configuration, then the Surface Mapping AI model can be retrained using additional training data.

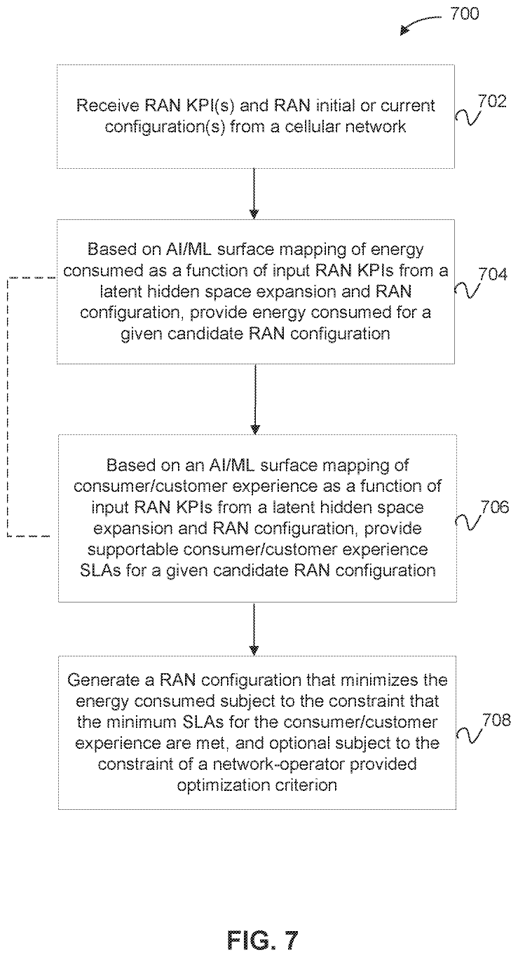

FIG. 7 is an illustration of a method 700 of: (i) using complex multi-dimensional surface mappers as a function of channel bandwidth, radio on/off status, MIMO configuration, and latent space for energy consumed, and (ii) consumer/customer experience to manage a cell network, according to one embodiment. The method 700 includes receiving RAN KPIs and RAN initial configurations from a cellular network, determining the energy consumed for a given candidate RAN configuration, determining supportable consumer/customer experience SLAs for a given candidate RAN configuration, and generating a RAN configuration that minimizes the energy consumed subject to the constraint that minimum SLAs for consumer/customer experience are met.

At operation 702, the method 700 includes receiving RAN KPIs and RAN initial or current configurations from a cellular network. The Equipment Management System provides access to RAN KPIs and the initial and/or current RAN configuration. The operator and the network equipment defines the KPIs and their granularity. By using the provided counters and KPIs, a ML trained fingerprinting block 150 analyzes the KPIs and expands the KPIs to include latent space information. The fingerprinting block 150 provides this latent space information to the network cell management system 105 where it is used as an input to the decision block 160 to provide a RAN Configuration update that meets the constrained optimization problem.

At operation 704, the method 700 includes providing the energy consumed for a given candidate RAN configuration. The network cell management system 105 uses the Energy Mapper AI model 340 to determine the energy consumed for a given candidate based on the surface mapping of energy consumed as a function of input RAN KPIs from a latent hidden space expansion and RAN configuration. A non-exhaustive list of examples of energy consumed includes at least one of: (i) picojoules per received bit on the uplink, (ii) picojoules per received bit on the downlink. In one embodiment, the method includes using complex multi-dimensional AI/ML trained surface mappers as a function of channel bandwidth, radio on/off status, MIMO configuration, and latent space to determine the energy consumed.

At operation 706, the method 700 includes providing supportable consumer/customer experience SLAs for a given candidate RAN configuration. The predictive network management system 105 uses the Function Mapper AI model 360 to determine the supportable consumer/customer experience SLAs for a given candidate RAN configuration based on a surface mapping of consumer/customer experience as a function of input RAN KPIs from a latent hidden space expansion and RAN configuration. A non-exhaustive list of examples of consumer experience includes at least one of: (i) maximum latency, (ii) outage probability, and (iii) minimum throughput.

Although operations 704 and 706 are depicted sequentially, operations 704 and 706 may be performed in parallel. Alternatively, operation 706 may be performed before operation 704. As used herein “in parallel” refers to operations that occur about the same time. The term “in parallel” is not intended to be limiting, and is intended to include additional operations not listed herein. In this way, operations 704 and 706 may occur at about the same time as each other and other operations on a system comprising one or more processors.

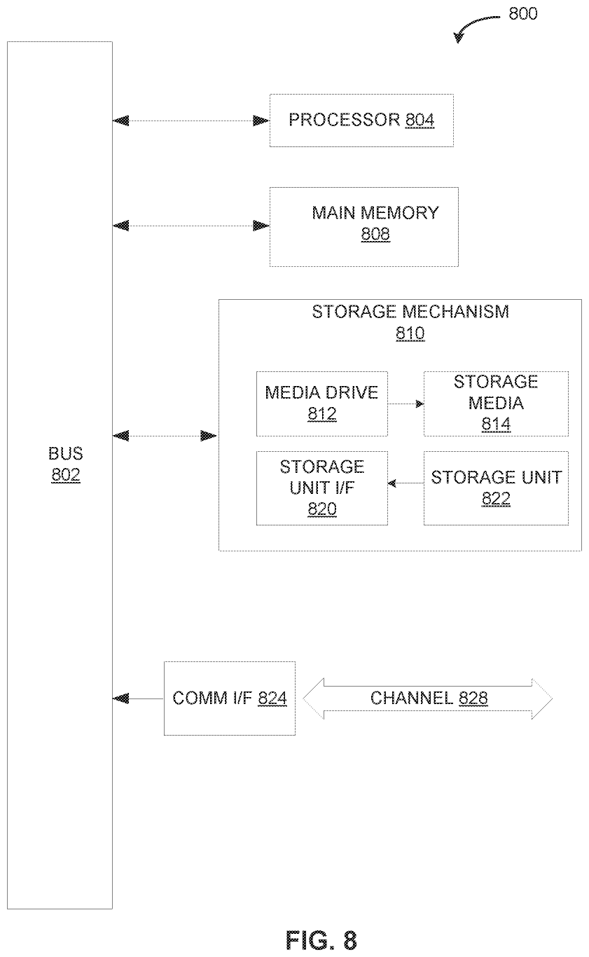

At operation 708, the method 700 includes generating a RAN configuration that minimizes the energy consumed subject to the constraint that the minimum SLAs for the consumer/customer experience are met and optionally subject to the constraint of a network-operator provided optimization criterion. The RAN configuration can be recommended to a cellular network to optimize RAN power consumption.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 8. Various embodiments are described in terms of this example computing module 800. After reading this description, it will become apparent to a person skilled in the relevant art how to implement the technology using other logical circuits or architectures.

FIG. 8 illustrates an example computing module 800, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAS, PALS, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display 812, input devices 814, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD or DVD drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface or network interface(s) 824. Communications or network interface(s) interface 824 might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 828. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 806, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and FIGs are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system, comprising:
one or more hardware processors; and
one or more non-transitory machine-readable storage media encoded with instructions that, when executed by the one or more hardware processors, cause the system to perform operations comprising:
obtaining key performance indictors (KPIs) and current configuration information for a radio access network (RAN) from equipment management services (EMS) of the RAN, the current configuration information describing a configuration of the RAN;
generating latent space information by expanding the KPIs; and
generating a configuration update for the RAN based on the current configuration information and the latent space information; and
providing the configuration update to the EMS.

2. The system of claim 1, wherein generating latent space information comprises:
applying the KPIs as input to a trained artificial intelligence (AI) model, wherein responsive to the input, the AI model outputs the latent space information, wherein the AI model has been trained with a training data set, and wherein the training data set includes (i) historical KPIs and/or historical latent space information and (ii) corresponding historical RAN configurations.

3. The system of claim 2, the operations further comprising:
validating the AI model by applying a testing data set as input to the AI model, wherein the testing data set is different from the training data set, and determining an error rate by comparing a resulting output of the AI model with known genie values.

4. The system of claim 3, the operations further comprising:
retraining the AI model using additional training data sets responsive to the error rate exceeding a threshold value.

5. The system of claim 1, wherein generating a configuration update comprises:
providing a candidate RAN configuration;
predicting energy that would be consumed by the RAN using the candidate RAN configuration based on the current configuration information and the latent space information;
determining a supportable customer experience that would be provided by the RAN using the candidate RAN configuration based on the current configuration information and the latent space information;
generating a RAN configuration that minimizes the energy that would be consumed by the RAN while providing the supportable customer experience; and
generating the configuration update based on the generated RAN configuration.

6. The system of claim 5, wherein predicting energy that would be consumed by the RAN comprises:
applying the current configuration information and the latent space information as input to a trained artificial intelligence (AI) model, wherein responsive to the input, the AI model outputs a prediction of the energy that would be consumed by the RAN using the candidate RAN configuration.

7. The system of claim 5, wherein determining a supportable customer experience that would be provided by the RAN comprises:
applying the current configuration information and the latent space information as input to a trained artificial intelligence (AI) model, wherein responsive to the input, the AI model outputs a determination of the supportable customer experience.

8. One or more non-transitory machine-readable storage media encoded with instructions that, when executed by one or more hardware processors of a computing system, cause the computing system to perform operations comprising:
obtaining key performance indictors (KPIs) and current configuration information for a radio access network (RAN) from equipment management services (EMS) of the RAN, the current configuration information describing a configuration of the RAN;
generating latent space information by expanding the KPIs; and
generating a configuration update for the RAN based on the current configuration information and the latent space information; and
providing the configuration update to the EMS.

9. The one or more non-transitory machine-readable storage media of claim 8, wherein generating latent space information comprises:
applying the KPIs as input to a trained artificial intelligence (AI) model, wherein responsive to the input, the AI model outputs the latent space information, wherein the AI model has been trained with a training data set, and wherein the training data set includes (i) historical KPIs and/or historical latent space information and (ii) corresponding historical RAN configurations.

10. The one or more non-transitory machine-readable storage media of claim 9, the operations further comprising:
validating the AI model by applying a testing data set as input to the AI model, wherein the testing data set is different from the training data set, and determining an error rate by comparing a resulting output of the AI model with known genie values.

11. The one or more non-transitory machine-readable storage media of claim 10, the operations further comprising:
retraining the AI model using additional training data sets responsive to the error rate exceeding a threshold value.

12. The one or more non-transitory machine-readable storage media of claim 11, wherein generating a configuration update comprises:
providing a candidate RAN configuration;
predicting energy that would be consumed by the RAN using the candidate RAN configuration based on the current configuration information and the latent space information;
determining a supportable customer experience that would be provided by the RAN using the candidate RAN configuration based on the current configuration information and the latent space information;
generating a RAN configuration that minimizes the energy that would be consumed by the RAN while providing the supportable customer experience; and
generating the configuration update based on the generated RAN configuration.

13. The one or more non-transitory machine-readable storage media of claim 12, wherein predicting energy that would be consumed by the RAN comprises:
applying the current configuration information and the latent space information as input to a trained artificial intelligence (AI) model, wherein responsive to the input, the AI model outputs a prediction of the energy that would be consumed by the RAN using the candidate RAN configuration.

14. The one or more non-transitory machine-readable storage media of claim 12, wherein determining a supportable customer experience that would be provided by the RAN comprises:
applying the current configuration information and the latent space information as input to a trained artificial intelligence (AI) model, wherein responsive to the input, the AI model outputs a determination of the supportable customer experience.

15. A computer-implemented method comprising:
obtaining key performance indictors (KPIs) and current configuration information for a radio access network (RAN) from equipment management services (EMS) of the RAN, the current configuration information describing a configuration of the RAN;
generating latent space information by expanding the KPIs; and
generating a configuration update for the RAN based on the current configuration information and the latent space information; and
providing the configuration update to the EMS.

16. The computer-implemented method of claim 15, wherein generating latent space information comprises:
applying the KPIs as input to a trained artificial intelligence (AI) model, wherein responsive to the input, the AI model outputs the latent space information, wherein the AI model has been trained with a training data set, and wherein the training data set includes (i) historical KPIs and/or historical latent space information and (ii) corresponding historical RAN configurations.

17. The computer-implemented method of claim 16, further comprising:
validating the AI model by applying a testing data set as input to the AI model, wherein the testing data set is different from the training data set, and determining an error rate by comparing a resulting output of the AI model with known genie values; and
retraining the AI model using additional training data sets responsive to the error rate exceeding a threshold value.

18. The computer-implemented method of claim 15, wherein generating a configuration update comprises:
providing a candidate RAN configuration;
predicting energy that would be consumed by the RAN using the candidate RAN configuration based on the current configuration information and the latent space information;
determining a supportable customer experience that would be provided by the RAN using the candidate RAN configuration based on the current configuration information and the latent space information;
generating a RAN configuration that minimizes the energy that would be consumed by the RAN while providing the supportable customer experience; and
generating the configuration update based on the generated RAN configuration.

19. The computer-implemented method of claim 18, wherein predicting energy that would be consumed by the RAN comprises:
applying the current configuration information and the latent space information as input to a trained artificial intelligence (AI) model, wherein responsive to the input, the AI model outputs a prediction of the energy that would be consumed by the RAN using the candidate RAN configuration.

20. The computer-implemented method of claim 18, wherein determining a supportable customer experience that would be provided by the RAN comprises:
applying the current configuration information and the latent space information as input to a trained artificial intelligence (AI) model, wherein responsive to the input, the AI model outputs a determination of the supportable customer experience.
